(19) United States
(12) Patent Application Publication
(10) Pub. No.: US 2024/0330345 A1
(43) Pub. Date: Oct. 3, 2024

(54) Systems and Methods for Generating Set of Suggestions for Enhancing Solutions for a Seed Problem using Large Language Models and Environmentally Sustainable Technologies

(71) Applicant: XLSCOUT XLPAT LLC, Wilmington, DE (US)

(72) Inventors: Sandeep Singh Kohli, Toronto (CA); Khushwant Rai, Mississauga (CA); Jitin Talwar, Panchkula (IN); Kriti Gogia, Mohali (IN); Punit Talwar, Mohali (IN); Nilesh Puntambekar, Mohali (IN); Manish Verma, Mohali (IN)

(73) Assignee: XLSCOUT XLPAT LLC, Wilmington, DE (US)

(21) Appl. No.: 18/625,229

(22) Filed: Apr. 3, 2024

Related U.S. Application Data
(60) Provisional application No. 63/456,633, filed on Apr. 3, 2023.

(51) Int. Cl. G06F 16/338; G06F 16/33; G06F 16/35; G06F 40/247

(52) U.S. Cl. CPC G06F 16/338; G06F 16/3334; G06F 16/353; G06F 40/247

(57) ABSTRACT

Technologies are described for a system and method to generate suggestions for seed problems. The system comprises one or more user devices, a database, at least one computer readable memory and at least one server comprising a processor unit. The system may be configured to receive a seed problem, identify one or more key features from the seed problem, generate one or more key concepts from the key features based on one or more of general technologies, environmentally sustainable technologies, and identified documents, and generate a set of suggestions based on user selected one or more key concepts. The system may be configured to identify the identified documents using text vectorization techniques based on the identified key features from a database. The system may be configured to further employ problem solving methodologies to analyze patterns of inventions in a global patent literature to generate the set of suggestions.

### FIELD OF DISCLOSURE

The present disclosure is generally related to systems and methods to provide a platform in an ideation phase for generating set of suggestions to enhance solution to seed problems, and particularly, to systems and methods for generating set of suggestions based on environmentally sustainable innovations using large language models (LLMs) and various problem-solving methodologies.

### BACKGROUND

Nowadays, the technology is improving rapidly. The advancement in technology is occurring due to the researchers and scientists that are continuously working in the area. There are different stages in innovation, staring from idea generation, idea selection, conceptualization, and to prototyping. In the current state of technology, inventors often face challenges in identifying novel and inventive aspects of their solutions, as well as ensuring that their solutions are technically sound and environmentally sustainable. Additionally, the inventors may struggle to find relevant information from existing patents and other sources that can help them improve their solutions and address the seed problems they aim to solve. Traditional methods for solving these problems include manual searching of patent databases, consulting with experts in the field, and using various problem-solving methodologies such as TRIZ, Six Sigma, Lean Manufacturing, Design Thinking, Systematic Inventive Thinking (SIT), Bio-inspired Design/Biomimicry, Quality Function Deployment (QFD), Six Thinking Hats, Blue Ocean Strategy, SCAMPER, Disruptive Innovation and combinations thereof. However, these methods can be time-consuming and may not always yield the desired results.

Prior art methods have attempted to address these challenges by using natural language processing (NLP) techniques to analyze patent data and extract relevant information. However, these prior art methods often lack the capability to effectively incorporate technical and environmentally sustainable innovations into the enhanced solutions and may not provide a comprehensive solution for inventors seeking to improve their solutions in these aspects.

Additionally, prior art methods may not utilize advanced large language models (LLMs) such as BERT, GPT-4, DistilBERT, RoBERTa, XLNet, T5, ALBERT, Electra, and their variants, modifications, and combinations thereof, which have demonstrated significant improvement in the performance of natural language understanding and generation tasks. The absence of such LLMs in prior art methods may limit their ability to effectively analyze patent data, extract key concepts, and generate enhanced solutions that incorporate technical and environmentally sustainable innovations.

In light of the limitations of traditional methods and prior art methods, there exists a need for a computer-implemented method that can effectively enhance solutions with general technical and environmentally sustainable innovations. Such a method should be capable of analyzing patent data and various problem-solving methodologies for extracting key concepts related to technical and sustainable innovation and generating enhanced solutions incorporating these concepts. Furthermore, the method should utilize advanced large language models and various problem-solving methodologies to provide a comprehensive solution for inventors seeking to enhance their solutions in terms of technical advancement and sustainability.

The present invention aims to provide a method and system that assists users in refining and enhancing their solutions with a focus on both technical advancement and environmental sustainability.

### SUMMARY

Technologies described herein relate to method and system for generating a set of suggestions to be used by a user to enhance solutions for seed problems.

According to an exemplary embodiment, a computer implemented method for generating a set of suggestions to be used by a user to enhance solutions for seed problems. The method comprises receiving a seed problem from a user device. The method further comprises identifying one or more key features from the seed problem. The method further comprises generating one or more key concepts from the identified one or more key features based on one or more of general technologies, environmentally sustainable technologies, and identified documents. The method further comprises selecting one or more of the generated key concepts. The method further comprises generation of the set of suggestions based on the selected one or more key concepts. The method further comprises displaying the generated set of suggestions to the user, via the user device.

In some examples, the method further comprises receiving a seed solution and/or a title corresponding to the seed problem from the user device.

In some examples, the method further comprises identifying the key features is further based on the seed solution, the title, in addition to the seed problem.

In some examples, the method further comprises identified documents are identified from a database based on the generated key features.

In some examples, the method further comprises creating a log of the user inputs and the identified key features, the generated key-concepts, and the generated set of suggestions.

In some examples, the method further comprises performing the steps of identifying the one or more key features comprises performing correlation among the words present in text corresponding to the seed problem, seed solution and title.

In some examples, the method further comprises performing the steps of identified documents are identified using a text vectorization technique based on the identified key features from a database.

In some examples, the method further comprises performing the steps of generating the one or more key concepts from the identified one or more key features based on one or more of the general technologies, environmentally sustainable technologies, and identified documents comprises following: • conducting correlation among the words present in the key features to identify relevant general technologies and environmentally sustainable technologies; and • employing patterns recognition to detect problem-solution pairs within the identified documents based on the relevant general technologies and environmentally sustainable technologies to generate the one or more key concepts.

In some examples, the method further comprises performing the steps of the generation of the set of suggestions based on the selected key-concepts comprises utilizing one or more technical problem solving methodologies to analyze patterns of inventions within a global patent literature database to generate the set of suggestions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates a general overview of a system for generating set of suggestions in accordance with the present disclosure.

FIG. 2 illustrates an exemplary block diagram representing internal structure of a server in accordance with one example of the subject matter of the present disclosure.

FIG. 3 illustrates a flowchart illustrating a method for generating set of suggestions in accordance with the one example of the subject matter of the present disclosure.

FIG. 4 illustrates an exemplary display showing generated one or more key concepts in form of clusters in accordance with the present disclosure.

FIG. 5 illustrates an exemplary display showing generated one or more suggestions in textual form in accordance with the present disclosure.

FIG. 6 illustrates a flowchart illustrating a method for generating set of suggestions in accordance with another example of the subject matter of the present disclosure.

FIG. 7 illustrates an exemplary block diagram representing internal structure of a server in accordance with another example of the subject matter of the present disclosure.

### DETAILED DESCRIPTION

Embodiments of the present invention are best understood by reference to the figures and description set forth herein. All the aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit and scope thereof, and the embodiments herein include all such modifications.

As used herein, the term ‘exemplary’ or ‘illustrative’ means ‘serving as an example, instance, or illustration.’ Any implementation described herein as exemplary or illustrative is not necessarily to be construed as advantageous and/or preferred over other embodiments. Unless the context requires otherwise, throughout the description and the claims, the word ‘comprise’ and variations thereof, such as ‘comprises’ and ‘comprising’ are to be construed in an open, inclusive sense, i.e., as ‘including, but not limited to.’

This disclosure is generally drawn, inter alia, to methods, apparatuses, systems, devices, non-transitory mediums, and computer program products implemented as automated tools for generating new concepts.

The present invention relates to a computer-implemented method for generating set of suggestions. The method comprises receiving a seed problem, optionally receiving a seed solution and a title associated with the seed problem, identifying of key features based on the seed problem, optionally on the seed solution and title, generation of key concepts based on the identified key features using one or more of general technologies, environmentally sustainable technologies and identified patent documents, generation of set of suggestions based on user's selected key concepts using one or more technical problem solving methodologies, displaying the generated set of suggestions to enhance the solutions to the user.

An example of a system may be configured to for generating a set of suggestions using general technology innovations and environmentally sustainable innovations. The system may be configured to receiving a seed problem, optionally receiving a seed solution and a title associated with the seed problem, identification of key features based on the seed problem, optionally on the seed solution and title, generation of key concepts based on the identified key features using one or more of identified key features using general technologies, environmentally sustainable technologies and identified patent documents, generation of set of suggestions based on user's selected key concepts using one or more technical problem solving methodologies, displaying the generated set of suggestions to the user.

In certain embodiments, the system, being configured to employ one or more problem-solving methodologies, such as TRIZ, Six Sigma, Lean Manufacturing, Design Thinking, Systematic Inventive Thinking (SIT), Bio-inspired Design/Biomimicry, Quality Function Deployment (QFD), Six Thinking Hats, Blue Ocean Strategy, SCAMPER, Disruptive Innovation, and combinations thereof. These methodologies facilitate the generation of inventive suggestions related to the selected key concepts.

In certain embodiments, the system, being configured to employ Large Language Learning Model (LLM) used by the processing unit may be selected from a group consisting of transformer-based models, recurrent neural networks (RNNs), and convolutional neural networks (CNNs). Transformer-based models may include BERT, GPT-4, DistilBERT, RoBERTa, XLNet, T5, ALBERT, Electra, and their variants, modifications, and combinations thereof.

In certain embodiments, the system, being configured to employ output interface unit to provide the user with a downloadable report that includes the set of suggestions, details of the general technical and environmentally sustainable key concepts, and a roadmap for implementing the generated enhanced set of solutions into a tangible invention prototype. This report can be used by the user to further develop their invention and potentially file for a patent application.

The method/system may be applied to various domains, such as energy, transportation, agriculture, manufacturing, construction, and waste management. For example, in the energy domain, the system may suggest key concepts related to renewable energy sources, energy efficiency, smart grids, energy storage, and energy management. In the transportation domain, the system may suggest key concepts related to electric vehicles, autonomous vehicles, vehicle-to-grid (V2G) technology, and sustainable transportation infrastructure.

The present invention provides several advantages, such as facilitating the generation of inventive and enhanced seed solution with a focus on technical advancement and sustainability, enhancing the user's invention by incorporating related concepts derived from existing patents, training datasets, company policies and additional sources of knowledge for providing a synthesized summary and roadmap for implementing the generated enhanced seed solution into a tangible invention prototype.

In the present invention the “seed problem” refers to the initial technological challenge, issue, or deficiency that an inventor or user aims to overcome or address. This problem is typically characterized by a specific need or gap in existing technologies, products, or processes that requires an innovative approach to resolve. The seed problem sets the stage for the inventive activity, providing the basis for identifying areas where improvements, advancements, or entirely new solutions are needed. It is the starting point from which the inventive process begins and against which the novelty and utility of potential solutions are measured as per existing patent laws in various jurisdictions.

In certain embodiments, the term “seed solution” in the present invention language pertains to the preliminary or initial idea, design, concept, or method proposed by the inventor or user to address the seed problem. It is the conceptual foundation or the first iteration of an invention that has the potential to evolve into a workable and innovative solution. While the seed solution may not be fully developed or refined, it represents the inventor's or user's original response to the identified problem and serves as a prototype or early version that can be further enhanced through analysis, experimentation, and iterative improvement. The seed solution may include basic sketches, descriptions, or models that illustrate how the inventor proposes to solve the seed problem.

In an embodiment of the present invention, “Key Concepts” represent the vital principles and innovative elements derived from “key-features” (i.e., a comprehensive analysis of the seed problem and/or seed solution), integrating both general technologies and environmentally sustainable technologies. This integration is facilitated through the use of advanced Large Language Models (LLMs) and an exhaustive examination of relevant technological literature, encompassing patent databases and industry standards. The inventor or user employs these key-concepts to advance the development of an enhanced solutions based on a set of suggestions, gaining insights into both the broader technological landscape and specific environmental sustainability considerations. By combining expertise from various technological domains with a commitment to eco-friendly innovation, the key-concepts steer the creation of novel, non-obvious solutions that are not only industrially applicable but also aligned with sustainable development goals, thereby increasing the potential for patentability and market success.

In certain embodiments, “General Technologies” encompasses a broad spectrum of established and emerging technological fields that serve as a rich source of data for the enhancement of solutions. This term refers to the array of existing technical knowledge, methodologies, tools, and innovations that span various industries and applications. The inventive process leverages these General Technologies to identify and extract key-concepts that can be applied to improve the preliminary seed solution. By integrating insights from General Technologies, the invention aims to advance the technical aspects of the seed solution, ensuring it is reflective of the latest advancements, optimally functional, and competitive within the relevant technological landscape.

In certain embodiments, “Environmentally Sustainable Technologies” specifically refers to the subset of technologies that prioritize ecological balance, resource efficiency, and minimal environmental impact. These technologies align with principles of sustainability or green technology and are critical for addressing the seed problem in a manner that is harmonious with environmental conservation goals. By incorporating Environmentally Sustainable Technologies into the inventive process, the present invention aims to generate key-concepts that not only solve the seed problem but do so in a way that contributes to the broader objectives of sustainability. This ensures that the enhanced solution based on a set of suggestions not only meets technical and market needs but also adheres to green standards, potentially reducing the ecological footprint and promoting long-term viability.

In the present invention the “set of suggestions” that refers to the improved and more sophisticated versions of the seed solution that have undergone further development, optimization, and refinement through the inventive process. This enhancement is achieved by integrating additional insights, key concepts, technological advancements, and environmentally sustainable innovations derived from various sources such as patent databases, large language models, and problem-solving methodologies. The set of suggestions represents a progression from the original seed solution, incorporating a broader range of considerations and inventive features that aim to address the seed problem more effectively. In patent terms, these enhanced solutions are expected to demonstrate increased novelty, non-obviousness, and industrial applicability, making them stronger candidates for patent protection and commercial exploitation.

In certain embodiments, the computer-implemented method for generating the set of suggestions, comprises integration of a variety of sustainability policies and frameworks at international, regional, and national levels. These policies and frameworks may include, but are not limited to, the United Nations Sustainable Development Goals (SDGs) and other green technology guidelines and standards. In certain embodiments, the system analyses the user's provided seed solution in light of the sustainability criteria to identify potential areas for improvement, thereby ensuring that the set of suggestions not only advances technical innovation but also aligns with environmental sustainability and social responsibility objectives.

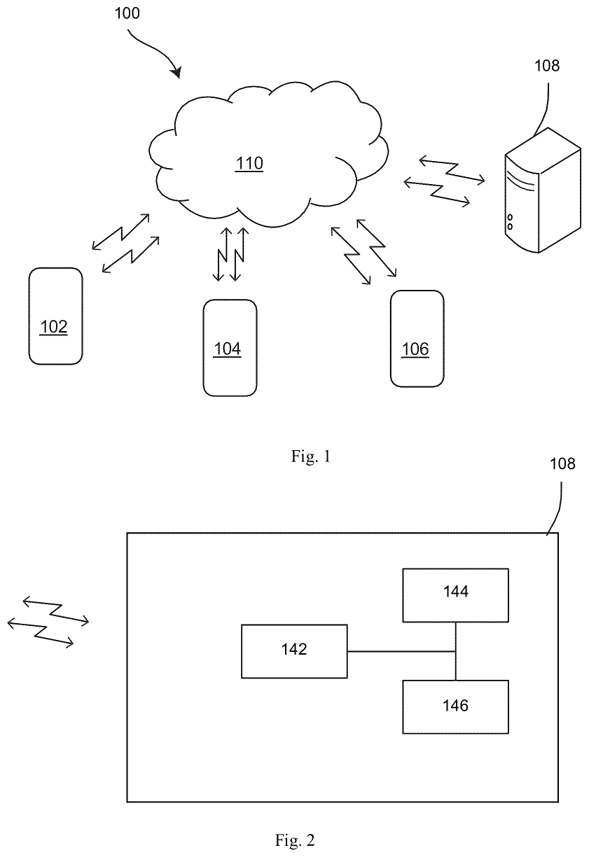

Referring to FIG. 1, a general overview of a system 100 for generating set of suggestions in accordance with the present disclosure is illustrated. The system 100 may comprise a server 108 and one or more devices 102, 104, 106. The server 108 and the one or more devices 102, 104, 106 may be communicatively coupled to each other using a communication network 110 to transfer information and data therebetween.

In an exemplary embodiment of the present disclosure, the one or more devices 102, 104, 106 may be configured to execute an application. The application may be implemented as a software application or a combination of software and hardware. Further, the application installed in the one or more devices 102, 104, 106 may be suitably configured to connect the one or more devices 102, 104, 106 with services offered by the server 108, and thus, the application may allow the respective users of the one or more devices 102, 104, 106 to access the system 100 for generating set of suggestions. In another exemplary embodiment, the one or more devices 102, 104, 106 may be configured to access functionalities of the server 108 of the present disclosure using any one of a plurality of available browsers. In an exemplary embodiment of the present disclosure, the functionalities of the remote server 108 may be implemented on a cloud network. The one or more devices 102, 104, 106 may have a plurality of user interfaces for facilitating different interaction with the system 100. For instance, the user device may include a first interface that facilitate providing the one or more inputs for generating set of suggestions.

In an embodiment of the present disclosure, the one or more devices 102, 104, 106 corresponding to a user may be configured to support the feature of generating and transmitting a request to the server 108 for generating set of suggestions. Some non-limiting examples of the one or more devices 102, 104, 106 include laptop and desktop computers, smartphones, tablets, and dedicated devices with transmitting and receiving features. In an embodiment, the system 100 may comprise multiple servers in communication with each other and dividing the functionality within the system 100.

FIG. 2 illustrates an exemplary block diagram representing internal structure of the server 108 in accordance with the present disclosure. The server 108 may comprise of a transceiver 142, a database 144, and a processing unit 146. The transceiver 142 of the remote server 108 may be configured to transmit and receive data with the one or more devices 102, 104, 106 in the communication network 110. In some embodiments, the transceiver 142 may be configured to receive one or more inputs from a user device for generating set of suggestions. The processing unit 146 may be configured to analyze the inputs and to generate set of suggestions corresponding to the one or more inputs. In certain embodiments, the processing unit 146 may co-operate with the database for generating set of suggestions. The database 144 of the server 108 may be configured to store a plurality of documents. The plurality of documents may include patent documents as well as non-patent literature such as, research papers, published articles, research thesis, published books, and the like.

The database 144 may be divided into a plurality of divisions, each of the plurality of divisions may correspond to a technical field, and/or a classification code. In an embodiment, the database 144 may be divided in different portions, each of the portions configured to store information related to a specific technical field. For instance, a first portion may include information related to a field of computer engineering, while a second portion may include information related to a field of electronics engineering. The information related to a specific technical field may include different components, their possible connections, different combination of components with their efficiency. For instance, the information related the field of computer engineering may include different computer languages, such as, C, C++, JAVA, python, and the like, and different directories, methods, and functions of corresponding computer language. In an embodiment, the database 144 may be communicatively coupled to an external database of related to the field of computer engineering. Similarly, the database may include information related to the field of electronics engineering, such as, basic electronics components, their possible connection, and circuits, such as, a low pass filter, a frequency generator, a comparator, a controller, and the like.

According to an exemplary embodiment, the system comprises a processor and a computer readable medium, and the system is implemented as computer readable and executable instructions stored on a computer readable medium for execution by a processor.

Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof. The system components may be provided by one or more server computers and associated components. According to an embodiment, the server may be configured to provide various functionalities of the present disclosure with execution of a set of instructions, stored in a database, by the processing unit. Further, the server communicates with the one or more user devices by the transceiver using the network. The communication network can be different wired and wireless communication networks, such as Internet, Intranet, PSTN, Local Area Network (LAN), Wide Area Network (WAN), Metropolitan Area Network (MAN), and so forth. The information storage, retrieval, update, and such activities in such database may be handled by the processing unit.

In an embodiment, a communication may be established between a device 102 of a user and a server 108 via the communication network 110. The device 102 may comprise a transceiver. The transceiver of the device 102 may be configured to transmit and receive data with the server 108. Further, the input transceiver of the device 102 may be configured to communicate with the server 108 for generating set of suggestions.

In an embodiment of the present disclosure, the one or more devices 102, 104, 106 corresponding any one of the users may be configured to generate a request to the server 108 for generating set of suggestions in the system 100. The transceiver 142 of the server 108 may be configured to receive the request from any one of the users for generating set of suggestions. Further, the request may be processed by the processing unit 146 of the server 108. In an embodiment, the server 108 may be configured to generate one or more suggestions corresponding to inputs of the user. The server 108 may be further configured to facilitate display of the generated set of suggestions on a display of the user device 102, 104, 106. Furthermore, the processing unit 146 of the server 108 may be configured to receive selection of the one or more combinations of the one or more suggestions via the user device. The server 108 may be further configured to generate enhanced solution corresponding to the received one or more combinations of the one or more suggestions. The one or more combinations of the one or more suggestions are to be displayed on the user device 102, 104, 106. The processing unit 146 of the server 108 may be configured to generate calculative data related to the field of the inputs provided by the user to be displayed to the user device 102, 104, 106.

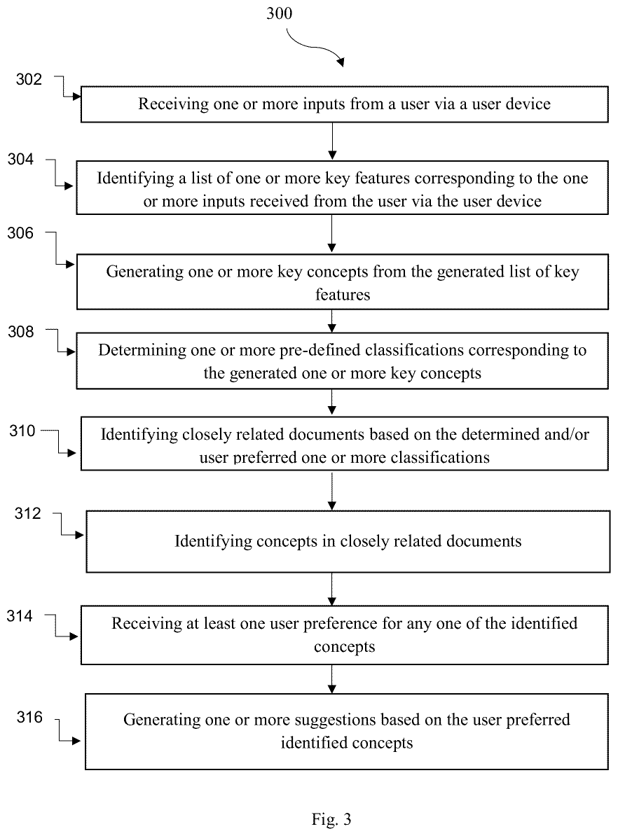

FIG. 3, which illustrates an exemplary flowchart illustrates a method 300 for generating set of suggestions in accordance with one example of the subject matter of the present disclosure. The method 300 may configured to be performed by using the system 100 as described in FIG. 1. Accordingly, all the components of the system 100 may be included hereinbelow for performing the method 300. In that, the server 108 of the system 100 may be configured to store the patent documents as well as non-patent documents in the database 144. The non-patent documents may include research papers, newspaper, or other technical articles. The database 144 may be divided in different portions, each of the portions configured to store information related to a specific technical field or a classification code for a field of invention. For instance, a first portion may include information related to a field of computer engineering, while a second portion may include information related to a field of electronics engineering. The term ‘classification code’ referred in the specification corresponds to an area of technology to which the inventions pertain.

The method 300 starts with step 302, in which the method 300 may comprise the step of receiving, by the server 108 one or more inputs from a user via one or more devices 102, 104, 106. For the same, the user may utilize a corresponding user interface of the one or more devices 102, 104, 106. In an embodiment, the one or more inputs may be considered as a request for generating set of suggestions. The one or more inputs may include a text corresponding to a seed problem to be solved, an explanation of an existing issue, a potential solution, an idea for solving an existing problem, and the like. The text may be in a natural language. In other words, the text may be in a language that is used general human conversation, and no specific format or structure of the text is required. Accordingly, the user does not require to be skilled in explaining a problem or an issue in highly technical terms or does not need to know a specific format, for example search strings, for providing inputs. The one or more inputs may further include information related to a patent or a patent application of an invention, such as, a patent number or a patent application number, a tittle of an invention, an abstract, an invention disclosure, a summary of an invention, and the like.

In step 304, the method 300 may include the step of identifying a list of one or more key features corresponding to the one or more inputs received from the user device. The server 108 may process the one or more inputs for identifying the list of one or more key features. The step of processing of the one or more inputs may include sub-steps such as, parsing of the one or more inputs to generate an array of words, removing stop words from the generated array of words, and forming a suitable text which corresponds to one or more key features. It is to be noted that the sub-steps may be further divided into more steps or may be combined so that the processing is performed in fewer sub-steps.

The step of key feature identification may include correlating different words in the one or more inputs with each other, thereby providing better correlation between the words that are placed far apart, for example, in a sentence.

For generating the at least one key feature, the system may include a key feature identification module. The key feature identification module may perform different steps of processing, as explained hereinabove, or correlating different words. The key feature generation module may utilize one or more artificial intelligence (AI) techniques.

In some embodiments, the identified at least one key feature may be displayed on a corresponding user interface of the user device 102. In such embodiments, the system 100 may facilitate the user to provide a key feature preference using which the user prefers to proceed in the method 300. In other words, if the user provides a key feature preference, then the system 100 considers the user preferred key feature for further processing, i.e., to generate one or more key concepts.

In step 306, one or more key concepts may be generated from the identified list of key features. The generated one or more key concepts may correspond to the one or more inputs provided by the user. The system 100 may include a key concept generation module for generating the one or more key concepts. The key concept generation module may utilize one or more AI techniques for the same. In certain embodiments, the key concept generation module utilizes most distantly related words from the identified at least one key feature for generating the one or more key concepts.

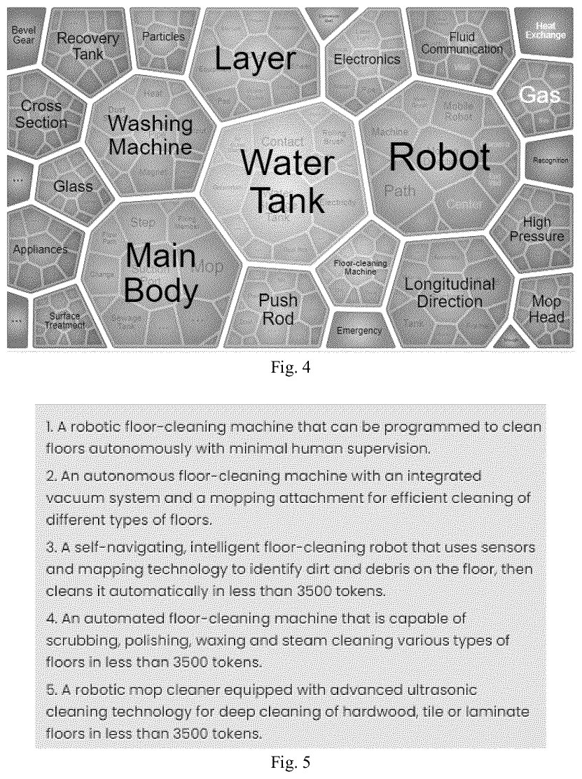

In some embodiments, the system 100 facilitates display of the generated one or more key concepts on a corresponding user interface on the one or more devices 102, 104, 106, as shown in FIG. 4. In such embodiments, the system 100 may further facilitate the user to select a preferred key concept from the generated one or more key concepts. Additionally, the system 100 may further facilitate the user to provide a key concept of their interest as an input using the corresponding user interface. The system 100 may perform further steps based on the user selected and/or user provided key concepts.

In step 308, one or more pre-defined classifications may be determined by the system 100 from the generated one or more key concepts. For the same, the system 100 may include a classification code generation module. The classification code generation module may be configured to determine one or more pre-defined technical fields in which the invention may lie. The classification code generation module may extract one or more synonyms for the generated one or more key concepts from a synonym database. The synonym database may include various synonyms of the words of different technologies. The synonym database may be divided into a plurality of divisions, each division corresponding to a specific technical field and may include words and synonyms for that technical field.

The classification code generation module may be trained on a classification training dataset. The training dataset may include a plurality of patent applications, a plurality of patents, and corresponding classification codes. In an embodiment, the training dataset may be stored in the database of the server 108. Optionally, the dataset may be stored in an external database communicatively coupled with the server 108.

In an embodiment, the invention may relate to more than one technology, for example in the field of Internet of Things (IoT), a plurality of technical fields, such as computer science, automation, electronics may be integrated. Accordingly, the classification code generation module may generate one or more pre-defined classification codes. As explained hereinabove, the term ‘classification code’ corresponds to an area of technology to which the inventions pertain.

In some embodiments, the system 100 may facilitate display of the determined one or more pre-defined classification codes on a corresponding user interface on the one or more devices 102, 104, 106. In such embodiments, the system 100 may further facilitate the user to select a preferred classification code from the generated one or more classification codes. Additionally, the system 100 may further facilitate the user to provide a classification code of their interest as an input using the corresponding user interface. The system 100 may perform further steps based on the user selected and/or user provided classifications.

It is to be noted that the generated at least one key feature, the one or more key concepts, and the one or more pre-defined classification are stored in the database 146, which may be extracted by the system 100 for determining a set of suggestions.

In step 310, the method 300 may identify closely related documents based on the determined and/or user preferred classifications. For the same, the system 100 may extract the closely related documents from the database 146 and generate a first list of documents including such identified documents. It is to be noted that the system 100 may also utilize the generated one or more key concepts stored in the database 146 for identifying closely related documents. The system 100 may include a document identification module for the same. The document identification module may generate vectors of the one or more key concepts and/or synonyms of words of the one or more key concepts for identifying closely related documents. For the same, the document identification module may perform contextual search using the vectors.

The method 300 may further extract the identified key feature(s) and the generated key concept(s) from database 146, parsing them to create a group of keywords. It then retrieves synonyms or related words from a synonym dataset stored in the synonym database, which may be referred to as a corpus. Method 300 generates search strings using different combinations of key features, key concepts, corresponding synonyms, and/or classification codes. These search strings are then used to extract closely related documents from database 144, generating a second list of documents.

In one embodiment, the first and second lists may be combined to create a single list. Alternatively, the method may allow a user to select either the first or second list for further processing, providing their selection through a corresponding user interface.

In certain embodiments, the user may modify the generated list (either the first list, the second list, or the combined single list) as per their interest. Such selection may be considered as feedback from the user. The user may provide a corresponding selection using a corresponding user interface. The server 108 may store the user selection of the documents from the list, which may be used by the system 108 as a user preference.

In step 312, the method 300 may comprise the step of identifying concepts in closely related documents, by creating summaries corresponding to each of the identified closely related documents. The summary may be in a natural language. In other words, the summary may be in a language that is easily understood by the user. Hence, no additional technical skill is required by the user to understand the summary. In case the identified closely related documents are patent applications or patents, then the summaries may be created using features from the abstract, summary and/or claims of that identified closely related documents.

In certain embodiments, the method 300 may comprise the step of identifying concepts in closely related documents, by extracting problem statement corresponding to each of the identified closely related documents. The problem statement may be in a natural language. In case the identified closely related documents are patent applications or patents, then the problem statement may be created using features from the abstract, description and/or background of that identified closely related documents.

In certain embodiments, the server 108 may be configured to generate matching percentages for identified documents. These matching percentages represent the correlation between user-provided inputs and the first list of documents. To identify closely related documents, server 108 may determine a technology associated with the identified key feature(s) and a classification code corresponding to the key feature(s). The method 300 then retrieves a set of documents from database 144 related to the identified classification code and generates the first list. Optionally, server 108 may rank the identified documents based on their matching percentages. In one embodiment, a predefined number of closely related documents with higher matching percentages are displayed on a user device in descending order, with the highest percentage ranked first and so forth.

In step 314, the method 300 may comprise the step of receiving by the server 108, at least one user preference for any one of the identified concepts using the user device 102. The at least one user preference may be selected from the one or more identified concepts. In an embodiment, the user may select a reference identified concepts from the one or more identified concepts. In another embodiment, the user may select a plurality of identified concepts from the set of identified concepts. In some embodiments, the user may select at least two or more suggestions for generating one or more suggestions.

In step 316, the method 300 may comprise the step of generating by the server 108, set of suggestions based on the user preferred identified concepts. The set of suggestions may be generated based user preferred concepts identified in the generated list of closely related documents. In an embodiment, the method 300 may comprise determining the set of suggestions based on the selection of synonyms and/or interoperable words from the user preferred concepts from the identified closely related documents. The server 108 may select the synonyms and/or the interoperable words for generating the set of suggestions. The synonyms may be converted into vectors and the set of suggestions may be generated based on contextual analysis of the identified and/or user preferred concepts in identified closely related documents. For the same, the server 108 may be configured to communicate with the database 144 to extract synonyms and interoperable words. In another embodiment, the method 300 facilitates the user to select a synonym and/or an interoperable word. In some embodiments, the server 108 may further facilitate the user to provide a user preferred synonym for further analysis using a corresponding user interface.

In certain embodiments, the method 300 may comprise generating by the server 108, the set of suggestions using the summaries created from each of the identified closely related documents. This process may include extracting concepts using problem-solving approaches, and potential improvements from the summaries, synthesizing them into unique, actionable suggestions. The server 108 may employ advanced text analysis and natural language processing techniques to effectively analyze the concepts and identify relevant themes, patterns, or trends. This process enables the generation of inventive suggestions that draw upon the collective knowledge encapsulated within the closely related documents, facilitating the development of novel solutions and fostering innovation in the target technology domain.

The one or more generated suggestions may be displayed on user interface on the one or more devices 102, 104, 106. The one or more suggestions may be displayed in clusters, a tabular form, a graphical form, a textual form, or any other form. An exemplary display for generated one or more suggestions is illustrated in FIG. 5.

The step of generation of one or more suggestions may include a step of generating a suggestion in a natural language. For instance, the generated one or more suggestions may be generated in a textual form that is easily understood by a researcher or a scientist. In other words, no additional skill, translation, or analysis is required by the researcher or the scientist to understand the generated one or more suggestions. For the same, different artificial intelligence techniques may be used. For instance, a large language model may be developed to generate the one or more suggestions based on the selection provided by the user. For generating the one or more suggestions in natural language, the large language model may be trained on a generative dataset. The generative dataset may include different fields, large set of examples of correlation of different fields, natural language sentences having features combining different fields with corresponding correlations, and the like.

The large language model may be in communication with the database 144 which may be divided in different portions, each of the portions configured to store information related to a specific technical field. At the time of generating the one or more suggestions, the large language model may communicate with the database 144 to identify one or more technical fields based on the generated at least one key feature, the one or more key concepts, and the one or more concepts selected by the user. The large language model then determines one or more probable associations between the identified fields to generate one or more suggestions. For example, if a generated suggestions from the at least one key feature is a floor cleaning and the user intends to generate an concept around automation in floor cleaning, then the large language model associates information from the field of electronic engineering and the field of automation and generates one or more corresponding suggestions, such as, use of different sensors, use of controller, real-time controlling of a floor cleaning device using mobile application, and the like.

In certain embodiments, the server 108 may be configured to form clusters for the generated one or more suggestions based on their similarities. It is to be noted that such generated suggestions may be transformed into text or sentences which are generally described in natural language. Exemplary generated suggestion for combination of the concept of floor cleaning with a user selection of automation is illustrated in FIG. 5, in which the generated suggestions are represented in natural text, and the user does not need specific skill or detailed understanding of any engineering field to understand the generated one or more extended suggestions. Such generated one or more suggestions are similar to human generated text and the generated one or more suggestions are difficult to distinguish from human-generated/written text. In other embodiments, the user may provide preference of display of the one or more generated suggestions either in form of an image, a text, or combination of both.

The generated one or more suggestions may be utilized by the user for further research and development. Accordingly, the system 100 and the method 300 of the present disclosure may provide a platform for researchers to perform ideation of concepts. Along with generation of the one or more suggestions, the system 100 and the method 300 may further stimulate different suggestions to the user and provide cues for further research. It is to be noted that the user may be a researcher, a scientist, or a research scholar. It is further to be noted that the system 100 and the method 300 may facilitate the user to provide a user preference at each step of the method. Accordingly, the system 100 and the method 300 may generate the one or more suggestion which are highly personalized and to the preference of the user, which may help user in quick one or more suggestions generation, while eliminating unwanted intermediate information altogether. In addition, the server 108 may utilize machine learning algorithms and other artificial intelligence tools to continually improve its suggestion generation capabilities, adapting to the evolving needs and preferences of users as well as the advancements in the technology landscape. This dynamic approach ensures that the generated suggestions remain relevant, valuable, and in line with the latest technological trends and industry best practices.

By incorporating the generation of innovative suggestions based on identified concepts of closely related documents, method 300 offers users a powerful tool for identifying and developing ground breaking solutions, thereby enhancing the overall effectiveness and impact of the inventive process.

In certain embodiments, the server 108 may facilitate the user to select at least one of the one or more generated suggestions to generate corresponding one or more extended suggestion. The server 108 may be configured to facilitate display of the one or more extended suggestions to the one or more devices 102, 104, 106. The generation of one or more extended suggestion may be facilitated by employing generative artificial intelligence (AI) techniques. These generative AI models can be specifically trained on technology data in order to generate innovative and pertinent technology ideas. In certain embodiments, the generative AI may be utilized as a core component in the suggestions generation process. This model may be trained on a diverse set of data sources, such as patent databases, research articles, whitepapers, industry reports, and other relevant technology-related content. By leveraging this extensive knowledge base, the generative AI can produce inventive suggestions that are both novel and grounded in the current state of the technology domain. The generative AI may also incorporate various machine learning techniques, such as deep learning, reinforcement learning, and unsupervised learning, to continually refine its suggestion generation capabilities. This adaptive approach allows the AI model to evolve alongside the rapidly changing technology landscape, ensuring that the generated suggestions remain relevant and up-to-date.

Furthermore, the generative AI may be designed to consider user preferences, technology trends, and market demands when generating extended suggestions. This ensures that the output is tailored to the specific needs of users and the challenges they face within their industry, thereby increasing the overall value and impact of the generated suggestions.

Accordingly, the present disclosure is advantageous in terms of providing a system 100 and a method 300 for generating set of suggestions. The present disclosure may provide a new technique that has been devised for generating set of suggestions for the user based on the inputs provided by the user.

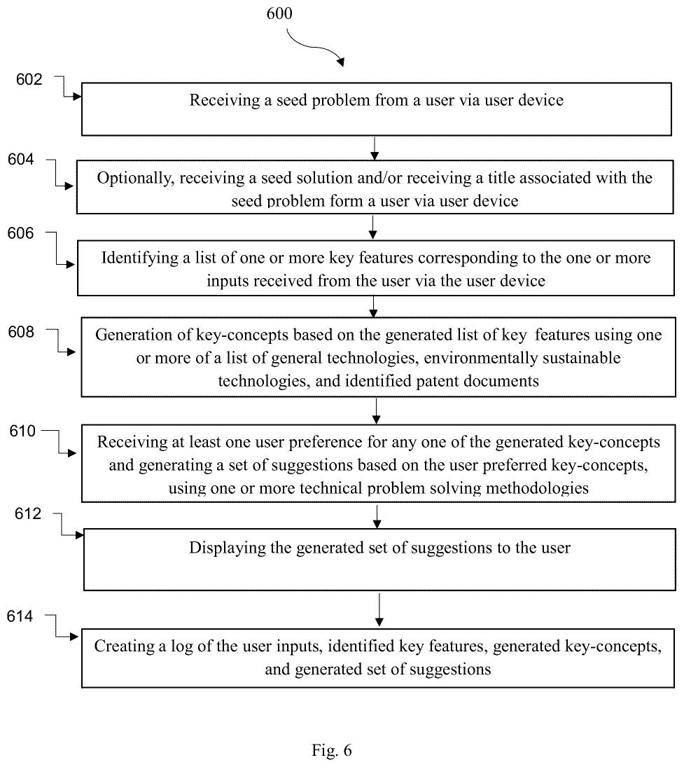

In a preferred embodiment, FIG. 6 illustrates an exemplary flowchart of a computer-implemented method for generation of set of suggestions for a seed problem according to another example of the subject matter of the present disclosure. The method 600 comprises, receiving a seed problem (block 602), optionally receiving a seed solution and a title associated with the seed problem (block 604), identifying a list of one or more key features corresponding to the seed problem and/or a seed solution and title (block 606), generation of key concepts based on the identified key features using one or more of the general technologies, the environmentally sustainable technologies, and identified patent documents (block 608), generating a set of suggestions based on the user preferred key concepts using one or more problem solving methodologies (block 610), displaying the generated set of suggestions to the user (block 612), creating a log of the inputs and generated set of suggestions (block 614).

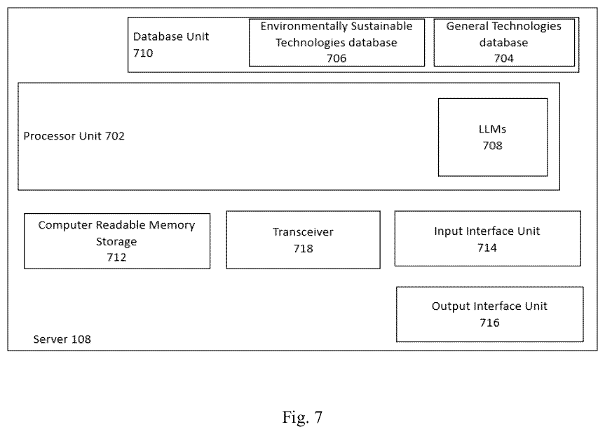

The method 600 may be implemented by a system 100 of FIG. 1 using server 108 such as the server 708 shown in FIG. 7.

Method 600 may include one or more operations, actions, or functions as illustrated by one or more of blocks 602, 604, 606, 608, 610, 612, and 614. Although illustrated as discrete blocks, various blocks may be divided into additional blocks, combined into fewer blocks, or eliminated, depending on the desired implementation. In some further examples, the various described blocks may be implemented as a parallel process instead of a sequential process, or as a combination thereof.

At block 602, a system (e.g., as one shown in FIG. 1) may be adapted to retrieve a seed problem from a user via user device. By way of example, but not limitation, the seed problem may be entered by a user via one or more devices 102, 104, 106 of the system 100.

By way of example, but not limitation, the seed problem may be entered in a from of a document including text file, image and like. By way of example, but not limitation, the seed problem may be entered by the user of the system, using an input device, such as keyboard and like. The seed problem is a written description of a problem in a language that is used general human conversation that the user/inventor aims to solve with his invention. By way of example, but not limitation, file type of the seed problem document may be pdf, word document, excel sheet, html page, etc.

At block 604, optionally, a server 108 (e.g., as one shown in FIG. 7) may be adapted to retrieve a seed solution and a title associated with the seed problem retrieved from a user via user device at block 602. By way of example, but not limitation, the seed solution and the title may be entered by a user of the system in a language that is used general human conversation. By way of example, but not limitation, the seed solution and the title may be entered in a form of a document including text file, image and like. By way of example, but not limitation, the seed solution and the title may be entered by the user using an input device, such as keyboard, and the like. The seed solution is a written detailed description of a solution that the user/inventor provides at his own to the system. The title may be a concise description of the solution in a language that is used general human conversation. By way of example, but not limitation, file type of the seed problem document may be pdf, word document, excel sheet, html page, etc.

At block 606, the server (e.g., as one shown in FIG. 7) may be adapted to identify a list of one or more key features corresponding to the one or more inputs received from the user via a user device at steps 602 and 604. The one or more received inputs comprises the seed problem and optionally the seed solution and title. The server 108 may process the one or more inputs for identifying the list of one or more key features. The step of processing of the one or more inputs may include sub-steps such as, parsing of the one or more inputs to identify an array of words, removing stop words from the identified array of words, and forming a suitable text which corresponds to one or more key features. It is to be noted that the sub-steps may be further divided into more steps or may be combined so that the processing is performed in fewer sub-steps. In certain embodiments, the system may be configured to generate one or more key concepts based on the seed problem. In certain embodiments, the system may be configured to generate one or more key concepts based on the seed problem, the seed solution, and the title associated with the seed problem.

The step of key feature generation may include correlating different words in the one or more inputs with each other, thereby providing better correlation between the words that are placed far apart, for example, in a sentence.

For generating the at least one key feature, the system may include a key feature identification module. The key feature generation module may perform different steps of processing, as explained hereinabove, or identification different words. The key feature identification module may utilize one or more LLMs.

At block 608, the server (e.g., as one shown in FIG. 7) may be adapted to generate key concepts based on the identified list of key features using one or more of general technologies, environmentally sustainable technologies, and identified patent documents. In certain embodiments, one or more problem solving methodologies may be incorporated in the system to generate one or more key concepts based on the general technologies and environmentally sustainable technologies and identified patent documents. In certain embodiments, user may select one or more of the identified key features through the display of the corresponding user device, which may be used at further steps in method 600, as user preferred key features.

Further, the system employs one or more LLMs to generate the key concepts based on the identified key features at block 606, using one of the identified patent documents, general technologies, environmentally sustainable technologies or combinations thereof, using patterns of problem-solution pairs in identified patents documents. In certain embodiments, the system may be configured to identify the plurality of patent documents based on either of the identified key features or the user's preferred key features using the text vectorization. In certain embodiments, the system may be configured to identify the plurality of patent documents based on the user's provided seed problem and optionally, on the seed solution and the title also using the text vectorization. In certain embodiments, a document identification module may generate vectors of the one or more key features and/or synonyms of words of the one or more key features for identifying closely related documents. For the same, the document identification module may perform contextual search using the vectors. In certain embodiments, the synonyms or related words are retrieved from a synonym dataset stored in a synonym database, which may be referred to as a corpus. The text vectorization technique(s) e.g., Binary Term Frequency, Bag of Words (BoW) Term Frequency, (L1) Normalized Term Frequency, (L2) Normalized TF-IDF, and Word2Vec are well known in the art.

For generating the at least one key concept, the system 100 utilize, processor unit 702, general technologies database 704, environmentally sustainable technological database 706, LLMs 708, and database unit 710.

In certain embodiments, the system employ one or more LLMs comprise artificial intelligence models trained on a corpus of text data selected from the group consisting of transformer-based models, recurrent neural networks (RNNs), and convolutional neural networks (CNNs), with the transformer-based models further selected from a subgroup consisting of BERT (Bidirectional Encoder Representations from Transformers), GPT-4 (Generative Pre-trained Transformer 4), DistilBERT, RoBERTa (Robustly optimized BERT approach), XLNet, T5 (Text-to-Text Transfer Transformer), ALBERT (A Lite BERT), Electra, and their variants, modifications, and combinations thereof.

At block 610, the server (e.g., as one shown in FIG. 7) may be adapted to receive at least one user preference for any one of the generated key concepts. The user can select one or more of the generated key concepts using the display of the corresponding user device, to be used as user preferred key concepts for further processing. By way of example, but not limitation, the system may select one or more generated key concepts corresponding to the general technologies and environmentally sustainable technologies, based on the user inputs. By way of example, but not limitation, the system may display the one or more key-concepts separately, based on the general technologies and environmentally sustainable technologies, on a suitable display device in any suitable form e.g., list, icons, grid and like. However, it should be understood to an ordinary skilled in the art that other methods of displaying are within the scope of this disclosure. The type of generated set of suggestions are contingent upon the corresponding technology from general technologies and environmentally sustainable technologies. For example, if the key concepts corresponding to the general technologies are being selected, then the generated set of suggestions would be associated with general technical innovations. On the other hand, if the key concepts corresponding to the environmentally sustainable technologies are being selected, then the generated set of suggestions would be associated with the environmentally sustainable innovations.

Further, at block 610, the server (e.g., as one shown in FIG. 7) may be adapted to generate a set of suggestions based on the user preferred key concepts, using one or more technical problem solving methodologies. In certain embodiments, the system employs one or more technical problem solving methodologies including but not limited to Triz Methodology and/or TRIZ separation principle to generate the set of suggestions using the key concepts, along with the LLMs and databases. The Triz methodology is a problem-solving, analysis, and forecasting technique derived from the analyze of patterns of invention in the global patent literature. It is based on the premise that there are universal principles of creativity that are the basis for creative innovations that advance technology.

In certain embodiments, the system can be configured to generate enhanced solutions using the set of suggestions or can combine one or more suggestions to generate one or more enhanced solutions. In certain embodiments, the system can be configured to generate enhanced solutions using the set of suggestions, and the seed solution provided by the user as an input. In certain embodiments, the system can be configured to generate enhanced solutions using the user’ selected set of suggestions, and the seed solution provided by the user as an input.

At block 612, the server (e.g., as one shown in FIG. 7) may be adapted to display the generated set of suggestions, using a suitable display device. By way of example, but not limitation, the display device may be a screen, monitor and like.

At block 614, the system can also configure to maintain a log of user's one or more inputs such as generated key concepts, generated key concepts, selected key concepts, seed problem, seed solution, title associated with seed problem, during the operation. Further, the system also can be configured to allow sharing of the generated set of suggestions.

In accordance with certain embodiments, the system may further comprise means for enabling the user to document and preserve a chronological record a log during the operations of the system at various steps of method 600. Additionally, the system may incorporate means for facilitating the dissemination of the aforementioned set of suggestions and/or enhanced solutions, such that the user may engage in the exchange of said suggestions and/or enhanced solutions with other entities. This may include, but is not limited to, the transmission of data over a network, the provision of access permissions to collaborative partners, and the utilization of sharing protocols to ensure the controlled and secure distribution of the intellectual property embodied in the suggestions and/or enhanced solutions.

FIG. 7 illustrates an exemplary block diagram representing internal structure of a server 108 in accordance with another example of the subject matter of the present disclosure.

FIG. 7 illustrates an exemplary block diagram representing internal structure of a server 108 in accordance with another example of the subject matter of the present disclosure, with additional specific modules/units included. As depicted in FIG. 7, the server 708 includes a processor unit 702, a general technologies database 704, an environmentally sustainable technologies database 706, a LLMs unit 708, a database unit 710, a computer readable memory storage 712, an input interface unit 714, an output interface unit 716, and a transceiver 718. With continued reference to FIG. 2, as non-limiting examples, the processor unit 702, the database unit 710, and the transceiver 718 may be substantially the same as the processor unit 146, the database unit 144, and the transceiver 142, as described previously herein. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof. The system components may be provided by one or more server computers and associated components.

In certain embodiments, the LLMs unit 708 may be configured to store large language models comprise artificial intelligence models trained on a corpus of text data selected from the group consisting of transformer-based models, recurrent neural networks (RNNs), and convolutional neural networks (CNNs), with the transformer-based models further selected from a subgroup consisting of BERT (Bidirectional Encoder Representations from Transformers), GPT-4 (Generative Pre-trained Transformer 4), DistilBERT, RoBERTa (Robustly optimized BERT approach), XLNet, T5 (Text-to-Text Transfer Transformer), ALBERT (A Lite BERT), Electra, and their variants, modifications, and combinations thereof.

In certain embodiments, the database unit 710 may be configured to store patent database, non-patent literature, one or more technical problem solving methodologies, synonyms database, training datasets, company policies, United Nations Sustainable Development Goals (SDGs), other green technology guidelines and additional sources of knowledge and like.

In certain embodiments, the computer readable memory storage 712 may be configured to store a set of instructions, which when executed by the processor unit 702, may cause the system 100 to perform the methods 300/600 as described above.

In certain embodiments, the processor unit 702 may be configured to some or all the operations of the methods 600 as detailed above. By way of example, but not limitation, the processor unit 702 may be configured to, receive a seed problem, optionally receiving a seed solution and a title associated with the seed problem, identify of the one or more key features, generate of key concepts based on the identified key features using one or more of identified key features using general technologies, environmentally sustainable technologies and identified patent documents, generate of set of suggestions based on user's selected key concepts using one or more technical problem solving methodologies, display the generated set of suggestions to the user on a display device and creating a log of the data during the operation of method 600.

In certain embodiments, the processor unit 702 may be configured to perform some or all the operations of the methods 600 as detailed above. By way of example, but not limitation, the processor unit 702 may configured to identify the key features based on the user inputs i.e., seed problem, seed solution and tittle using the text vectorization or using the LLMs unit 708.

In certain embodiments, the processor unit 702 may be configured to perform some or all the operations of the methods 600 as detailed above. By way of example, but not limitation, the processor unit 702 may configured to generate the one or more key concepts based on the key features using the LLMs unit 708, using general technologies, environmentally sustainable technologies, and identified patent documents. In certain embodiments, the processor unit 702 may be configured to identify the plurality of patent documents based on the identified key features from the patent database of the database unit 710. In certain embodiments, the processor unit 702 may utilize natural language processing unit (NLP) (not shown) to use NLP techniques to interpret and summarize the content of identified patents, training data thereby enabling the extraction of identified concepts in a format that is easily understandable by the user. Examples of NLP techniques include tokenization, stemming, lemmatization, part-of-speech tagging, named entity recognition, and sentiment analysis.

In certain embodiments, by way of example, but not limitation, the processor unit 702 is configured to access the general technology database 704 to generate the general technology based one or more key concepts using the identified key features and the LLMs unit 708.

In certain embodiments, by way of example, but not limitation, the processor unit 702 may be configured to perform some or all the operations of the methods 100 as detailed above. By way of example, but not limitation, the processor unit 702 is configured to access the environmentally sustainable technology database 704 to generate the environmentally sustainable technologies based one or more key concepts using the identified key features and the LLMs unit 708.

In certain embodiments, the processor unit 702 may be configured to perform some or all the operations of the methods 600 as detailed above. By way of example, but not limitation, the processor unit 702 may be configured to generate set of suggestions based on the user's selected key concepts using the LLMs unit 708, along with one or more technical problem solving methodologies. By way of example, but not limitation, the processor unit 702 is configured to access the database 710 for one or more technical problem solving methodologies.

In certain embodiments, the input interface unit 714 may be configured to provide an input interface to a user of the system 100, to provide a user's input. By way of example, but not limitation, the input may include the seed problem, a seed solution and a title associated with the seed problem. By way of example, but not limitation, the input may include selection of the one or more of the identified key features, key concepts generated for the general technologies and environmentally sustainable technologies. By way of example, but not limitation, the input interface unit 714 may include a mouse, display keyboard, joystick, touchpad, touch screen, voice recognition unit, or any other input unit known to a person having ordinary skill in the art.

In certain embodiments, the output interface unit 716 may be configured to provide an output interface to display or render an output to a user of the system 100. By way of example, but not limitation, the output may include display of set of suggestions. By way of example, but not limitation, the output interface unit 716 may include a display screen, touch screen, audio unit, projector unit, or any other output unit known to a person having ordinary skill in the art. By way of example, but not limitation, the generated enhanced seed solution may be complied and displayed. The output interface can also provide the user with a downloadable report that includes the synthesized summary, details of the technical and sustainable key concepts selected, and a roadmap for implementing the set of suggestion into a tangible invention prototype.

It is to be noted herein that various aspects and objects of the present invention described above as method and process should be understood to an ordinary skilled in the art as being implemented using a system that includes a computer that has a CPU, display, memory and input devices such as a keyboard and mouse. According to an embodiment, the system is implemented as computer readable and executable instructions stored on a computer readable media for execution by a general or special purpose processor. The system may also include associated hardware and/or software components to carry out the above-described method functions. The system is preferably connected to an internet connection to receive and transmit data.

The term “computer-readable media” as used herein refers to any medium that provides or participates in providing instructions to the processor of the computer (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random-access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all of the features, aspects and advantages are necessarily required to practice the present invention. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention. The inventions may be embodied in other specific forms not explicitly described herein. The embodiments described above are to be considered in all respects as illustrative only and not restrictive in any manner.

1. A computer implemented method for generating a set of suggestions to be used by a user to enhance solutions for seed problems, the method comprising:
receiving a seed problem from a user device;
identifying one or more key features from the seed problem;
generating one or more key concepts from the identified one or more key features based on one or more of general technologies, environmentally sustainable technologies, and identified documents;
selecting one or more of the generated key concepts;
generation of the set of suggestions based on the selected one or more key-concepts; and
displaying the generated set of suggestions to the user, via the user device.

2. The computer implemented method of claim 1, further comprising receiving a seed solution and/or a title corresponding to the seed problem from the user device.

3. The computer implemented method of claim 2, wherein generating the key concepts is further based on the seed solution, the title, in addition to the seed problem.

4. The computer implemented method of claim 1, wherein the environmentally sustainable technologies are green technologies and the like.

5. The computer implemented method of claim 1, wherein the identified documents are identified from a database based on the identified key features.

6. The computer implemented method of claim 1, wherein the selection of one or more of the generated key-concepts is performed by the user, via the corresponding user device.

7. The computer implemented method of claim 1, wherein the seed problem is a technical challenge that the user aims to solve.

8. The computer implemented method of claim 1, further comprising creating a log of the user inputs and the identified key features, the generated key-concepts, and the generated set of suggestions.

9. The computer implemented method of claim 2, wherein identifying the one or more key features comprises performing correlation among the words present in text corresponding to the seed problem, seed solution and title.

10. The computer implemented method of claim 1, wherein the identified documents are identified using a text vectorization technique based on the identified key features from a database.

11. The computer implemented method of claim 1, wherein generating the one or more key concepts from the identified one or more key features based on one or more of the general technologies, environmentally sustainable technologies, and identified documents comprises following:
conducting correlation among the words present in the key features to identify relevant general technologies and environmentally sustainable technologies; and
employing patterns recognition to detect problem-solution pairs within the identified documents based on the relevant general technologies and environmentally sustainable technologies to generate the one or more key concepts.

12. The computer implemented method of claim 1, wherein the generation of the set of suggestions based on the selected key-concepts comprises utilizing one or more technical problem solving methodologies to analyze patterns of inventions within a global patent literature database to generate the set of suggestions.

13. The computer implemented method of claim 12, wherein the problem-solving methodologies comprises at least one of the methodologies like but not limited to Theory of Inventive Problem Solving (TRIZ), six Sigma, lean manufacturing, design thinking, Systematic Inventive Thinking (SIT), bio-inspired design/Biomimicry, Quality Function Deployment (QFD), six thinking hats, blue ocean strategy, SCAMPER, disruptive innovation or a combination thereof.

14. A system to generate a set of suggestions to be used by a user to enhance solutions for seed problems, the system comprising:
one or more user devices;
a database;
at least one computer readable memory; and
at least one server comprising a processor unit coupled to the at least one computer readable memory, wherein the processor is configured to:
receive a seed problem from the user device;
identify one or more key features from the seed problem;
generate one or more key concepts from the identified one or more key features based on one or more of general technologies, environmentally sustainable technologies, and identified documents, wherein the general technologies, environmentally sustainable technologies, and identified documents are retrieve from the database;
select one or more of the generated key concepts based on the user's selection performed through the user device;
generate the set of suggestions based on the selected one or more key-concepts; and
display the generated set of suggestions to the user, via a display of the user device.

15. The system of claim 14, wherein the at least one processor is further configured to receive a seed solution and/or a title corresponding to the seed problem from the user device.

16. The system of claim 15, wherein the at least one processor is further configured to identify the key features further based on the seed solution and the title, in addition to the seed problem.

17. The system of claim 14, wherein the at least one processor is further configured to:
create a log of the user inputs and the identified key features, the generated key-concepts, and the generated set of suggestions; and
store the created log in the database.

18. The system of claim 16, wherein the at least one processor being configured to identify the one or more key features is further configured to perform correlation among the words present in text corresponding to the seed problem, seed solution, and title.

19. The system of claim 14, wherein the at least one processor is further configured to identify the identified documents using a text vectorization technique based on the identified key features from the database.

20. The system of claim 14, wherein the at least one processor being configured to generate the one or more key concepts from the identified one or more key features based on the one or more of the general technologies, environmentally sustainable technologies, and identified documents, is further configured to:
conduct correlation among the words present in the key features to identify relevant general technologies and environmentally sustainable technologies; and
employ patterns recognition to detect problem-solution pairs within the identified documents based on the relevant general technologies and environmentally sustainable technologies to generate the one or more key concepts.

21. The system of claim 14, wherein the at least one processor being configured to generate the set of suggestions based on the selected key-concepts, further configured to employ one or more technical problem solving methodologies to analyze patterns of inventions in a global patent literature to generate the set of suggestions, wherein the database further comprises the global patent literature.

22. The system of claim 21, wherein the problem-solving methodologies comprises at least one of the methodologies like but not limited to—Theory of Inventive Problem Solving (TRIZ), six Sigma, lean manufacturing, design thinking, Systematic Inventive Thinking (SIT), bio-inspired design/Biomimicry, Quality Function Deployment (QFD), six thinking hats, blue ocean strategy, SCAMPER, disruptive innovation or a combination thereof.

23. The system of claim 14, further comprising one or more Large Language Models (LLMs), wherein the at least one processor is further configured to employ one or more LLMs to:
identify the one or more key features;
identify the identified documents from the database based on the identified key features;
generate the one or more key concepts; and
generate the set of suggestions based on the selected key-concepts.

24. The system of claim 23, wherein the one or more LLMs comprises at least one of BERT, GPT-4, DistilBERT, RoBERTa, XLNet, T5, ALBERT, Electra, and the like.

25. A computer implemented method for generating a set of suggestions to be used by a user to enhance solutions for seed problems, the method comprising:
receiving a plurality of inputs comprising a seed problem, seed solution, and title from a user device;
identifying one or more key features from the plurality of inputs;
generating one or more key concepts from the identified one or more key features;
determining one or more pre-defined classifications corresponding to the generated one or more key-concepts;
identifying a plurality of related documents from a database based on the determined one or more classifications;
identifying one or more concepts from the identified related documents;
selecting one or more of the identified concepts, from the user device;
generation of the set of suggestions based on the one or more selected concepts; and
displaying the generated set of suggestions to the user, via the user device.

26. The computer implemented method of claim 25, wherein identifying the one or more key features comprises performing correlation among the words present in text corresponding to the plurality of user inputs.

27. The computer implemented method of claim 25, wherein generating the one or more key concepts comprises performing correlation among the words present in the one or more key features.

28. The computer implemented method of claim 25, wherein determining one or more pre-defined classifications comprises determining corresponding technical fields of the one or more key concepts.

29. The computer implemented method of claim 25, wherein identifying the plurality of related documents from the database based on the determined one or more classifications comprises the use of text vectorization.

30. The computer implemented method of claim 25, wherein identifying the one or more concepts comprises creating summaries corresponding to each of the identified documents, to extract a problem-statement corresponding to each of the identified related documents.

31. The computer implemented method of claim 30, wherein generation of the set of suggestions based on the one or more selected concepts comprises utilizing the created summaries of the related documents corresponding to the selected concepts.
